(19) United States
(12) Patent Application Publication
(10) Pub. No.: US 2010/0088919 A1
(43) Pub. Date: Apr. 15, 2010

(54) AIR-DRYING ASSEMBLY

(76) Inventors: Feng-Ying YANG, Changzhi Township (TW); Kuo-Cheng CHIU, Changzhi Township (TW)

Correspondence Address: PATENTTM.US, P. O. BOX 82788, PORTLAND, OR, 97282-0788, US

(21) Appl. No.: 12/573,517

(22) Filed: Oct. 5, 2009

(30) Foreign Application Priority Data
Oct. 15, 2008 (TW) 097218373

(51) Int. Cl. F26B 25/06

(52) U.S. Cl. 34/202

(57) ABSTRACT

An air-drying assembly has a cabinet and an air conditioner. The cabinet has a door, a drying space, an air outlet, a fan and a drain device. The drying space is formed in the cabinet. The air outlet communicates with the drying space and outside of the cabinet. The fan is mounted near the air outlet in the cabinet. The drain device is mounted under the drying space in the cabinet. The air conditioner has an exhaust port that is mounted in the cabinet and communicates with the drying space. When the air conditioner is operated, airflow exhausted from the exhaust port can dry clothing or tableware in the drying space. Kinetic energy and heat energy of airflow is not wasted to provide an energy-saving effect.

### BACKGROUND OF THE INVENTION

1. Field of the Invention

The present invention relates to an air-drying assembly, and more particularly to an air-drying assembly having a drying function by using air exhaust from an air conditioner.

2. Description of Related Art

An air conditioner is a home appliance, system or mechanism designed to extract heat from or provide heat to an area. People use air conditioners to adjust indoor temperature for comfort. An air conditioner is operated based on a principle of heat exchange and exhausts hot air in a cooling cycle and exhausts cool air in a heating cycle. The airflow and heat energy exhausted from an air conditioner can be useful to do something but they have not been used so far. If the airflow and heat energy exhausted from an air conditioner can be used to replace some energy-consuming mechanism or provide an auxiliary power, an energy-saving effect can be provided.

Therefore, the present invention provides an air-drying assembly to mitigate or obviate the aforementioned problems.

### SUMMARY OF THE INVENTION

An objective of the invention is to provide an air-drying assembly having a drying function by using exhaust from an air conditioner.

The air-drying assembly has a cabinet and an air conditioner. The cabinet has a door, a drying space, an air outlet, a fan and a drain device. The drying space is formed in the cabinet. The air outlet communicates with the drying space and outside of the cabinet. The fan is mounted near the air outlet in the cabinet. The drain device is mounted under the drying space in the cabinet. The air conditioner has an exhaust port that is mounted in the cabinet and communicates with the drying space. When the air conditioner is operated, airflow exhausted from the exhaust port can dry clothing or tableware in the drying space. Kinetic energy and heat energy of airflow is not wasted to provide an energy-saving effect.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of an air-drying assembly in accordance with the present invention;

FIG. 2 is a front view of the air-drying assembly in FIG. 1 with a door removed;

FIG. 3 is an operational side view in partial section of the air-drying assembly in FIG. 1;

FIG. 4 is a perspective view of a second embodiment of an air-drying assembly in accordance with the present invention;

FIG. 5 is a front view of the air-dry assembly in FIG. 4 with a door removed;

FIG. 6 is an operational side view in partial section of the air-drying assembly in FIG. 4;

FIG. 7 is an operational side view in partial section of a third embodiment of an air-drying assembly in accordance with the present invention with an exhaust port formed above the drying space; and

FIG. 8 is a side view in partial section of a fourth embodiment of an air-drying assembly in accordance with the present invention with shelves mounted in a cabinet.

### DETAILED DESCRIPTION OF PREFERRED EMBODIMENT

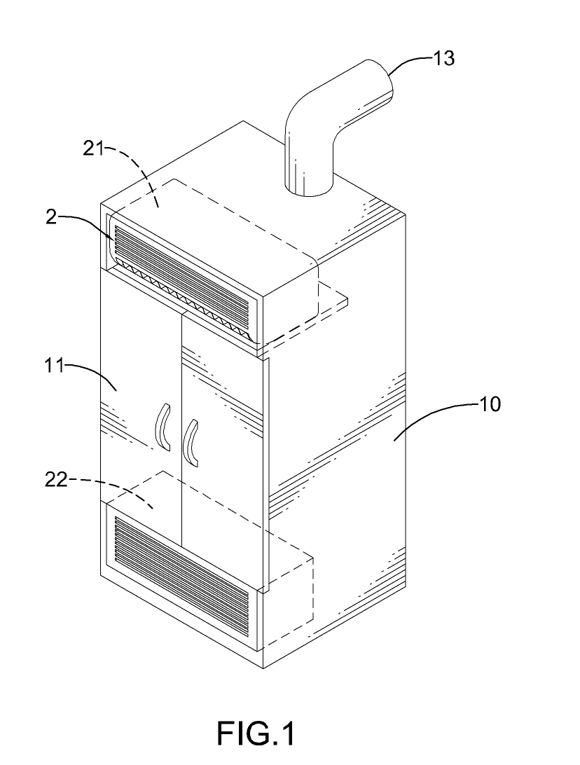

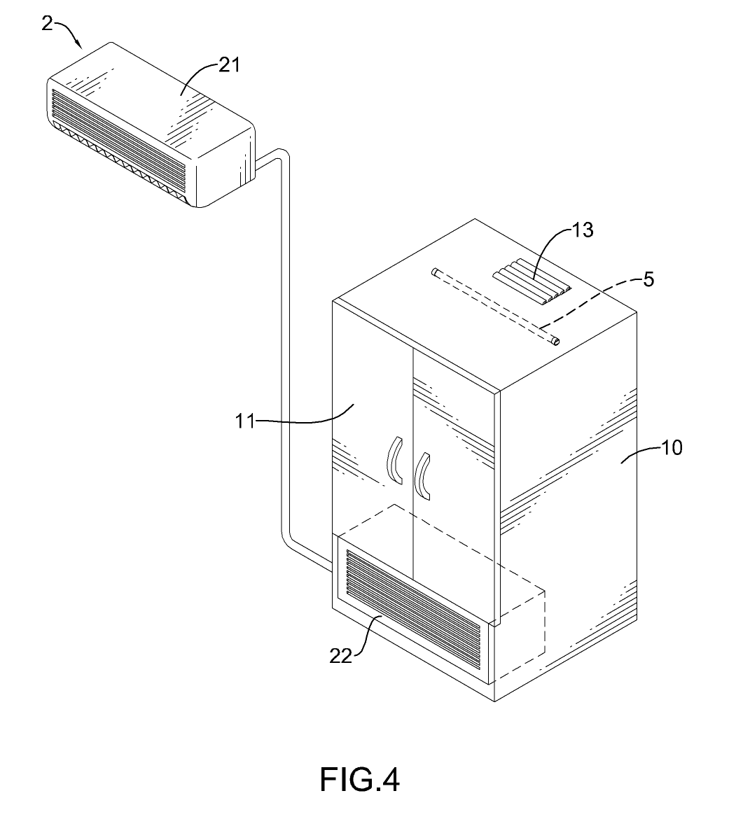

With reference to FIGS. 1 and 4, an air-drying assembly comprises a cabinet (10) and an air conditioner (2).

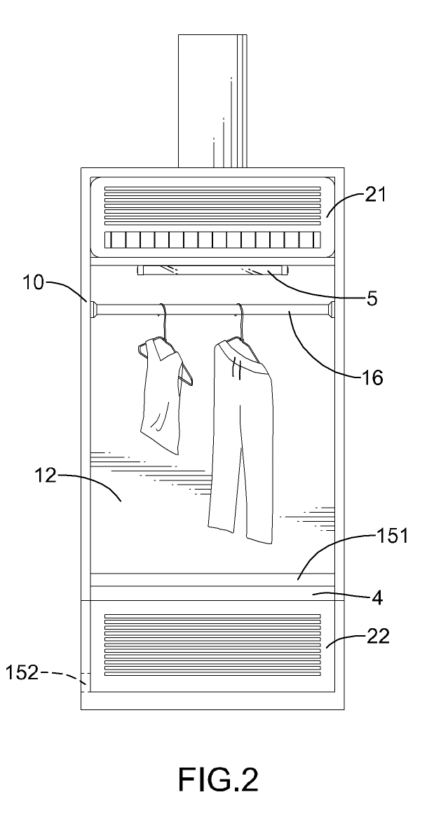

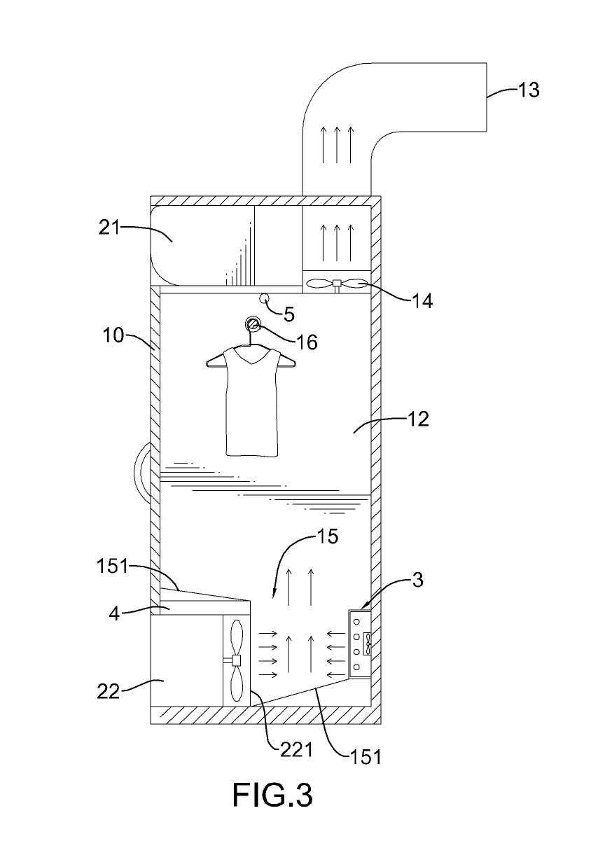

With reference to FIGS. 1 to 3, in the first preferred embodiment in accordance with the present invention, the cabinet (10) has a door (11), a drying space (12), an air outlet (13), a fan (14) and a drain device (15) and may further have at least one hanging rod (16), a heater (3), an ozonizer (4) and at least one ultraviolet lamp (5). The drying space (12) is formed in the cabinet (10). The air outlet (13) may be mounted on a top of the cabinet (10) to communicate with the drying space (12) and an outside of the cabinet (10). The fan (14) is mounted in the drying space (12) near the air outlet (13) in the cabinet (10). The drain device (15) is mounted under the drying space (12) in the cabinet (10) and may have at least one water pan (151) and a water outlet (152). The water outlet (152) is mounted on a bottom of the cabinet (10), and the at least one water pan (151) is mounted near the water outlet (152) to guide water to the water outlet (152). The hanging rod (16) is mounted in the drying space (12). The heater (3) is mounted under the drying space (12) in the cabinet (10). The ozonizer (4) may be mounted above the outdoor unit (22) in the drying space (12). The ultraviolet lamp (5) may be mounted on a top of the cabinet (10) in the drying space (12).

The air conditioner (2) has an exhaust port (221) that is mounted in the cabinet (10) and communicates with the drying space (12). In a preferred embodiment, the air conditioner (2) may be a split-type air conditioner having an indoor unit (21) and an outdoor unit (22). The indoor unit (21) is mounted above the drying space (12) in the cabinet (10). The outdoor unit (22) has the exhaust port (221) and is mounted under the drying space (12) in the cabinet (10).

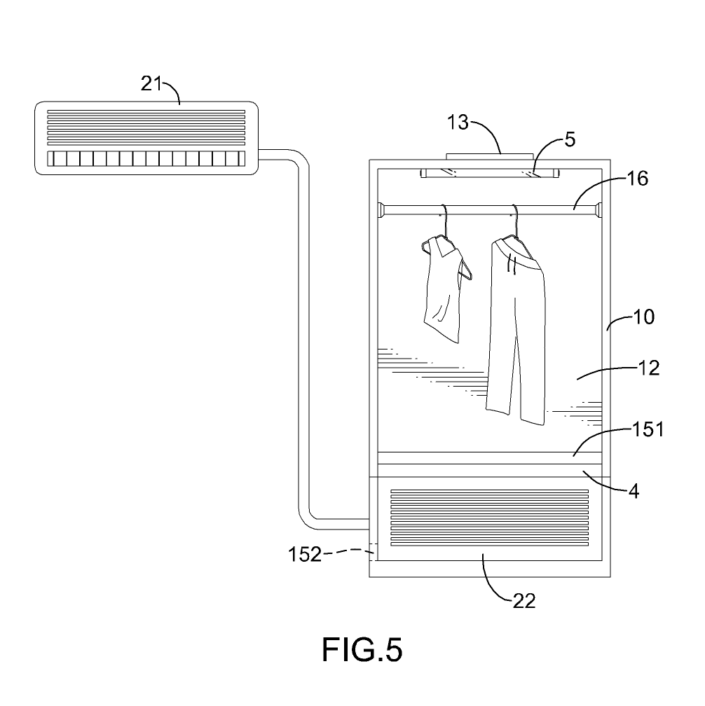

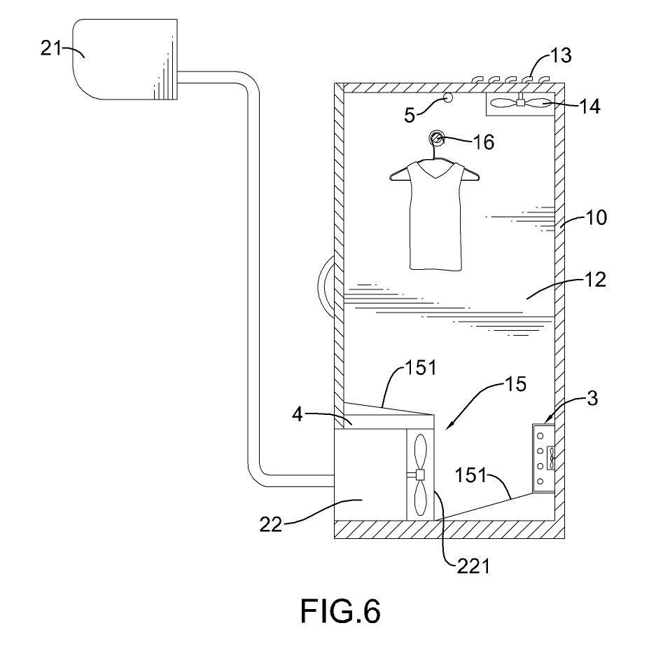

With reference to FIGS. 4 to 6, in the second preferred embodiment in accordance with the present invention, the indoor unit (21) of the air conditioner (2) is mounted outside of the cabinet (10) and is connected to the outdoor unit (22) by tubing. The air outlet (13) is defined in the top of the cabinet (10).

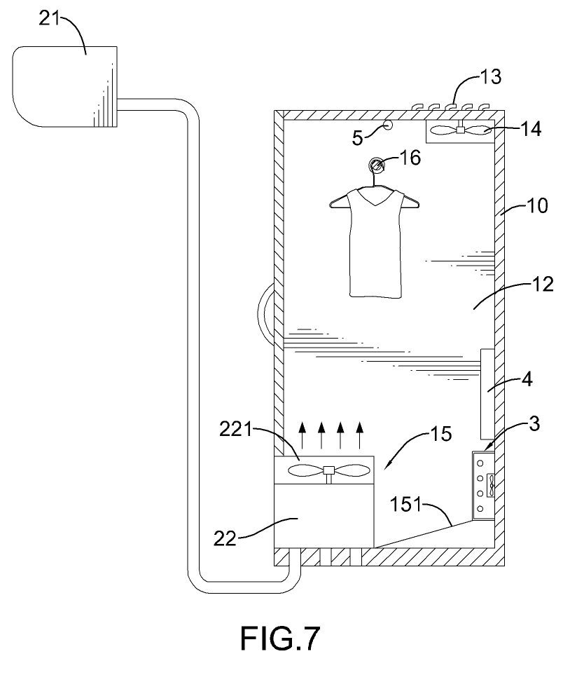

With reference to FIG. 7, in the third preferred embodiment in accordance with the present invention, the exhaust port (221) of the outdoor unit (22) may be mounted in the bottom of the cabinet (10) and face upward to the drying space (12) to increase convection.

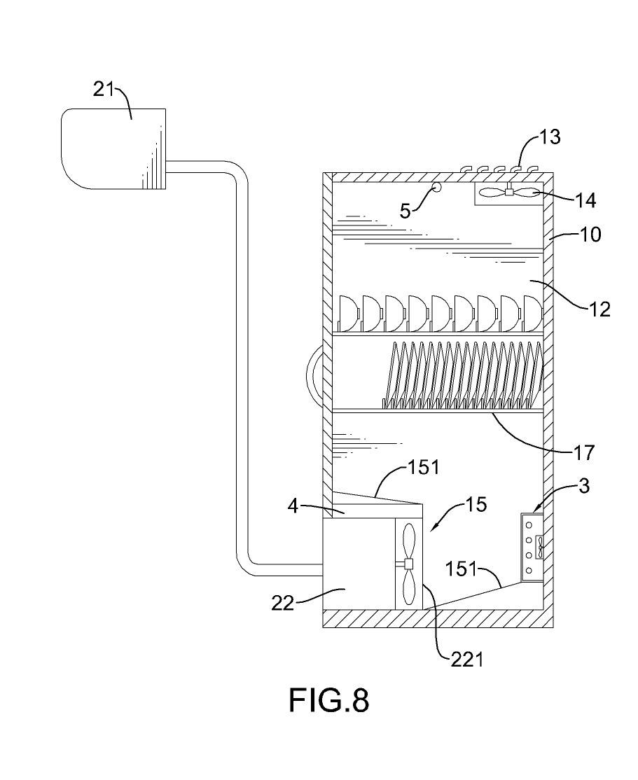

With reference to FIG. 8, in the fourth preferred embodiment in accordance with the present invention, the cabinet (10) may have at least one shelf (17) mounted in the drying space (12) for holding tableware.

When the air-drying assembly in accordance with the present invention is in use, wet clothing can be hung on the hanging rod (16) or tableware can be put on the shelf (17) in the drying space (12). When the air conditioner (2) is turned on, airflow exhausted from the outdoor unit (22) of the air conditioner (2) is blown into the drying space (12) to dry clothing or tableware, especially dry objects by heat in a cooling cycle. The humid airflow can be exhaust out from the air outlet (13) by the fan (14). The heater (3) can work independently or provide an additional drying effect. Water emanating from clothing or tableware can be guided by the water pan (151) and exhausted from the water outlet (152). In addition, the ozonizer (4) and the ultraviolet lamp (5) further provide an object sanitizing function.

The air-drying assembly in accordance with the present invention provides a drying function by using airflow exhausted from an air conditioner (2), and if the air conditioner (2) is in a cooling cycle, heat energy of heat flow can be use to dry objects by heat. The kinetic energy of airflow and heat energy thereof is not wasted and an energy-saving effect is provided.

Even though numerous characteristics and advantages of the present invention have been set forth in the foregoing description, together with details of the structure and function of the invention, the disclosure is illustrative only. Changes may be made in detail, especially in matters of shape, size, and arrangement of parts within the principles of the invention to the full extent indicated by the broad general meaning of the terms in which the appended claims are expressed.

What is claimed is:

1. An air-drying assembly comprising:
a cabinet having
a door;
a drying space formed in the cabinet;
an air outlet communicating the drying space with outside of the cabinet;
a fan mounted near the air outlet in the cabinet; and
a drain device mounted under the drying space in the cabinet; and
an air conditioner having an exhaust port that is mounted in the cabinet and communicates with the drying space.

2. The air-drying assembly as claimed in claim 1, wherein the air conditioner is a split-type air conditioner having an indoor unit and an outdoor unit, and the outdoor unit having the exhaust port is mounted under the drying space in the cabinet.

3. The air-drying assembly as claimed in claim 2, wherein the indoor unit is mounted above the drying space in the cabinet.

4. The air-drying assembly as claimed in claim 2, wherein the indoor unit is mounted outside of the cabinet.

5. The air-drying assembly as claimed in claim 1, wherein the cabinet has at least one hanging rod mounted in the drying space of the cabinet.

6. The air-drying assembly as claimed in claim 2, wherein the cabinet has at least one hanging rod mounted in the drying space of the cabinet.

7. The air-drying assembly as claimed in claim 1, wherein the cabinet has at least one shelf mounted in the drying space of the cabinet.

8. The air-drying assembly as claimed in claim 2, wherein the cabinet has at least one shelf mounted in the drying space of the cabinet.

9. The air-drying assembly as claimed in claim 1, wherein the cabinet has a heater mounted on a bottom of the drying space.

10. The air-drying assembly as claimed in claim 6, wherein the cabinet has a heater mounted on a bottom of the drying space.

11. The air-drying assembly as claimed in claim 8, wherein the cabinet has a heater mounted on a bottom of the drying space.

12. The air-drying assembly as claimed in claim 6, wherein the drain device has at least one water pan and a water outlet, the water outlet is mounted on a bottom of the cabinet and the at least one water pan mounted near the water outlet.

13. The air-drying assembly as claimed in claim 8, wherein the drain device has at least one water pan and a water outlet, the water outlet is mounted on a bottom of the cabinet and the at least one water pan is mounted near the water outlet.

14. The air-drying assembly as claimed in claim 6, wherein the cabinet has an ozonizer mounted in the cabinet and communicates with the drying space.

15. The air-drying assembly as claimed in claim 8, wherein the cabinet has an ozonizer mounted in the cabinet and communicates with the drying space.

16. The air-drying assembly as claimed in claim 6, wherein the cabinet has at least one ultraviolet lamp mounted in the drying space of the cabinet.

17. The air-drying assembly as claimed in claim 8, wherein the cabinet has at least one ultraviolet lamp mounted in the drying space of the cabinet.
